(19) United States
(12) Patent Application Publication
(10) Pub. No.: US 2024/0078592 A1
(43) Pub. Date: Mar. 7, 2024

(54) SALES INFORMATION PROCESSING APPARATUS, SALES INFORMATION PROCESSING METHOD, AND NON-TRANSITORY STORAGE MEDIUM

(71) Applicant: NEC Corporation, Minato-ku, Tokyo (JP)

(72) Inventors: Rina TOMITA, Tokyo (JP); Yuji TAHARA, Tokyo (JP)

(73) Assignee: NEC Corporation, Minato-ku, Tokyo (JP)

(21) Appl. No.: 18/273,905

(22) PCT Filed: Jun. 30, 2021
(86) PCT No.: PCT/JP2021/024776

§ 371 Date: Jul. 24, 2023

(51) Int. Cl. G06Q 30/0601

(52) U.S. Cl. CPC G06Q 30/0639; G06Q 30/0627

(57) ABSTRACT

A sales information processing apparatus (10) includes a sales data acquisition unit (130) and a graph display unit (140). The sales data acquisition unit (130) acquires sales data of a first store and sales data of a second store. The graph display unit (140) causes a display (150) to display a graph having two axes representing a sales result and a disposal result. Further, the graph display unit (140) displays, in the graph displayed on the display (150), a first position corresponding to the first store and a second position corresponding to the second store. The graph display unit (140) determines the first position and the second position by using the sales data acquired by the sales data acquisition unit (130).

### TECHNICAL FIELD

The present invention relates to a sales information processing apparatus, a sales information processing method, and a program.

### BACKGROUND ART

In order to improve operation efficiency of a store, it is necessary to transmit information relating to a sales performance of the store to a store clerk or the like. Patent Document 1 describes that a server supporting a beauty salon causes a store terminal to display performance information of an own store and performance information of another store. In Patent Document 1, the server acquires a condition for narrowing down other stores from the store terminal.

### RELATED DOCUMENT

### Patent Document

Patent Document 1: Japanese Patent Application Publication No. 2003-76760

### DISCLOSURE OF THE INVENTION

### Technical Problem

One of products displayed in a store is a product having an expiration date or a best-by date. For such a product, when the number of orders (the number of cooked items for in-store cooking items) is too large, a product that has passed the expiration date or the best-by date before being sold, that is, a product to be disposed, is occurred. On the other hand, when the number of orders is too small, a sales opportunity will be lost, and the sales of the store will be lowered. Therefore, the sales result and the disposal result of the store are important indicators when operating a store.

One object of the present invention is to enable a store clerk to easily recognize quality of a sales result and a disposal result of a store.

### Solution to Problem

One aspect of the present invention provides a sales information processing apparatus including:
a sales data acquisition unit that acquires sales data which enable determination of a sales result and a disposal result of a first store, and a sales result and a disposal result of a second store; and
a graph display unit that displays, on a display, a graph having two axes representing a sales result and a disposal result, and displays, in the graph, a first position corresponding to the first store and a second position corresponding to the second store by using the sales data.

One aspect of the present invention provides a sales information processing apparatus including:
a sales data acquisition unit that acquires, from a sales storage unit that stores data of each of a plurality of stores, sales data which enable determination of a sales result and a disposal result of a first store; and
a position determination unit that determines a quadrant to which a first position corresponding to the sales data belongs in a graph having at least two axes representing a sales result and a disposal result, wherein,
in the graph, zero point of each axis is an average value of a plurality of stores, and
the sales information processing apparatus further including
   an evaluation generation unit that generates evaluation information of the first store by using a quadrant determined by the position determination unit.

One aspect of the present invention provides a sales information processing method including,
by a computer to execute:
sales data acquisition processing of acquiring sales data which enable determination of a sales result and a disposal result of a first store, and a sales result and a disposal result of a second store; and
graph display processing of displaying, on a display, a graph having two axes representing a sales result and a disposal result, and displaying, in the graph, a first position corresponding to the first store and a second position corresponding to the second store by using the sales data.

One aspect of the present invention provides a sales information processing method including,
by a computer to execute:
sales data acquisition processing of acquiring, from a sales storage unit that stores data of each of a plurality of stores, sales data which enable determination of a sales result and a disposal result of a first store; and
position determination processing of determining a quadrant to which a first position corresponding to the sales data belongs in a graph having at least two axes representing a sales result and a disposal result, wherein,
in the graph, zero point of each axis is an average value of a plurality of stores, and
the sales information processing method further including,
by the computer to execute
   evaluation generation processing of generating evaluation information of the first store by using a quadrant determined in the position determination processing.

One aspect of the present invention provides a program for causing a computer to include:
a sales data acquisition function of acquiring sales data which enable determination of a sales result and a disposal result of a first store, and a sales result and a disposal result of a second store; and
a graph display function of displaying, on a display, a graph having two axes representing a sales result and a disposal result, and displaying, in the graph, a first position corresponding to the first store and a second position corresponding to the second store by using the sales data.

One aspect of the present invention provides a program causing a computer to include:
a sales data acquisition function of acquiring, from a sales storage unit that stores data of each of a plurality of stores, sales data which enable determination of a sales result and a disposal result of a first store; and
a position determination function of determining a quadrant to which a first position corresponding to the sales data belongs in a graph having at least two axes representing a sales result and a disposal result, wherein,
in the graph, zero point of each axis is an average value of a plurality of stores, and
the program further causing the computer to include
   an evaluation generation function of generating evaluation information of the first store by using a quadrant determined by the position determination function.

### Advantageous Effects of Invention

According to one aspect of the present invention, a store clerk can easily recognize quality of a sales result and a disposal result of a store.

### BRIEF DESCRIPTION OF THE DRAWINGS

The above-described object and other objects, features and advantages will become more apparent from the following description of suitable example embodiments and the accompanying drawings thereof.

FIG. 1 It is a diagram illustrating a functional configuration of a sales information processing apparatus according to a first example embodiment.

FIG. 2 It is a diagram for describing one example of a selection rule of a second store being used by a second store selection unit.

FIG. 3 It is a diagram illustrating an example of a hardware configuration of a sales information processing apparatus.

FIG. 4 It is a flowchart illustrating one example of processing performed by a sales information processing apparatus.

FIG. 5 It is a diagram illustrating one example of a screen being displayed on a display in step S60 of FIG. 4.

FIG. 6 It is a diagram illustrating one example of a functional configuration of a sales information processing apparatus according to a second example embodiment.

FIG. 7 It is a diagram illustrating one example of a screen displayed on a display in the second example embodiment.

### DESCRIPTION OF EMBODIMENTS

Hereinafter, example embodiments of the present invention will be described with reference to the drawings. Note that, in all the drawings, the same components are denoted by the same reference numerals, and description thereof will be omitted as appropriate.

### First Example Embodiment

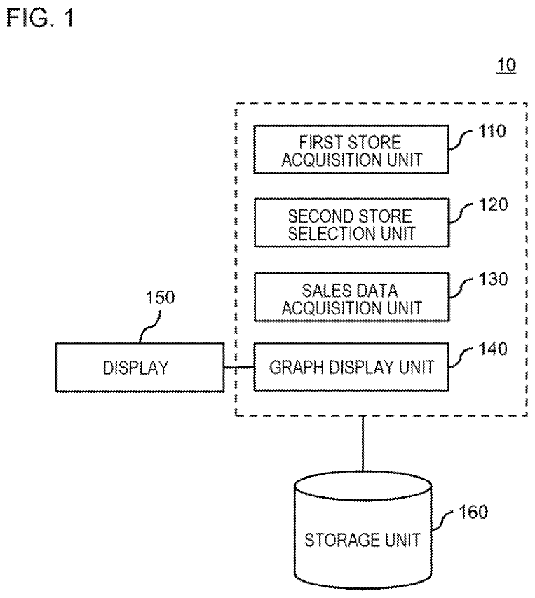

FIG. 1 is a diagram illustrating a functional configuration of a sales information processing apparatus 10 according to the present example embodiment. The sales information processing apparatus 10 displays data (hereinafter, referred to as sales data) related to sales of a certain store (hereinafter, referred to as a first store) in a state where the data can be compared with sales data of another store (hereinafter, referred to as a second store). Thereby, it becomes easier for a store clerk of the first store to objectively recognize the performance of the first store. It is preferable that the sales data include at least a sales result and a disposal result. Further, the sales data is managed by product and period (for example, by day and time slot).

The sales result is at least one of the sales amount and the number of sales, and the disposal result is at least one of the disposal amount and the number of disposal. The disposal amount is a total value of selling prices or cost prices of the products which were disposed before being sold. The reason why a product is disposed is, for example, that a predetermined sales deadline has passed before the product is sold. One example of a product to be subject of sales data is a food product. One example of such food product is a product having a short sales deadline (for example, a product having a sales deadline of one day or less after being displayed in the store), such as an in-store cooking item or a lunch box.

The sales information processing apparatus 10 includes a sales data acquisition unit 130 and a graph display unit 140. Further, the sales information processing apparatus 10 may use data stored in a storage unit 160. The storage unit 160 stores various types of data to be used by the sales information processing apparatus 10.

The sales data acquisition unit 130 acquires sales data of the first store and sales data of the second store. Although there is only one first store, there may be a plurality of second stores. Such sales data are stored in the storage unit 160. The storage unit 160 also stores sales data of stores other than the first store and the second store.

The graph display unit 140 causes a display 150 to display a graph having two axes representing a sales result and a disposal result. The graph may have yet another axis. In such a case, the graph is a three-dimensional graph. The graph display unit 140 displays a first position corresponding to the first store and a second position corresponding to the second store in the graph displayed on the display 150. The graph display unit 140 determines the first position and the second position by using the sales data acquired by the sales data acquisition unit 130. When there are a plurality of second stores, the graph display unit 140 displays the positions of each of the plurality of second stores in the graph.

The sales information processing apparatus 10 further includes a first store acquisition unit 110 and a second store selection unit 120.

The first store acquisition unit 110 acquires information for determining the first store (hereinafter, referred to as first store determination information). The first store discrimination information is, for example, a store ID or a store name. The first store determination information is input by, for example, a store clerk of the first store. However, the first store determination information may be stored in the storage unit 160 in advance. In such a case, the first store acquisition unit 110 acquires the first store determination information from the storage unit 160.

The second store selection unit 120 uses the first store determination information acquired by the first store acquisition unit 110 to select a store which has an attribute close to that of the first store as the second store. Specifically, the storage unit 160 stores the attribute of the store for each of the plurality of stores. The second store selection unit 120 acquires, from the storage unit 160, an attribute associated with the first store determination information acquired by the first store acquisition unit 110, and selects a store associated with such attribute or a store similar to such attribute as the second store. One example of the attribute is a location condition of the store. The selection rule of the second store being used by the second store selection unit 120 will be described later with reference to another drawing.

Then, the sales data acquisition unit 130 acquires, from the storage unit 160, sales data associated with the first store determination information acquired by the first store acquisition unit 110, and also acquires, from the storage unit 160, sales data associated with the second store selected by the second store selection unit 120. However, the first store and the second store may be specified in advance. In such a case, the sales information processing apparatus 10 may not include the first store acquisition unit 110 and the second store selection unit 120.

Note that, the sales data acquisition unit 130 may acquire, from the store clerk, information (hereinafter, referred to as product specification information) for specifying a product to be a target of the sales data. The product specification information may be a product code or a product name. In such a case, the sales data acquisition unit 130 acquires sales data of the product indicated by the product specification information.

Further, the sales data acquisition unit 130 may acquire, from the store clerk, information (hereinafter, referred to as period specification information) for specifying a period to be a target of the sales data. The period specified herein is quarterly, monthly, weekly, or daily units. The period may be further divided into time zones in the case of daily units. In such a case, the sales data acquisition unit 130 acquires sales data of a period indicated by the period specification information.

The sales information processing apparatus 10 may be installed in the first store or may be installed in a management center that manages a plurality of stores. In the latter case, the first store acquisition unit 110 acquires the first store determination information from a store terminal installed in the first store. The store terminal may be a portable terminal (for example, a smartphone or a tablet terminal) possessed by a store clerk, or may be a fixed terminal. The display 150 is connected to the store terminal. The graph display unit 140 transmits, to the store terminal, data for displaying the graph on the display 150.

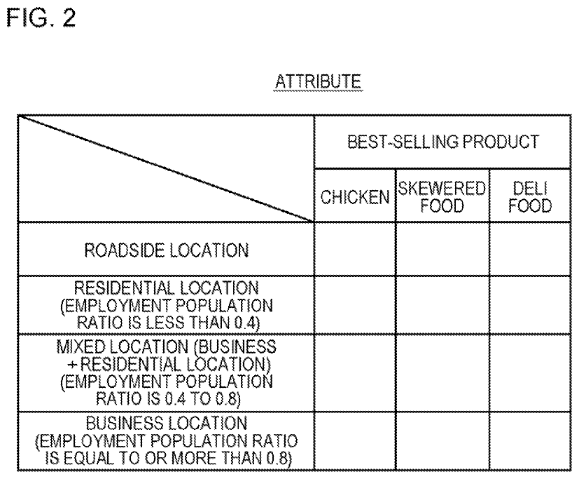

FIG. 2 is a diagram for describing one example of a selection rule of the second store being used by the second store selection unit 120. The plurality of stores are classified in advance into a plurality of groups by using attributes. One example of an attribute is a location condition (classes in the vertical direction in FIG. 2). The location condition is first classified according to whether the store is located on the roadside, e.g., whether the store is facing a highway. Then, stores that are not located on the roadside are further classified by using an employment population ratio. One example of the employment population ratio is [employment population around the store]/[(number of households around the store)+(employment population around the store)]. Note that, the wording [around the store] implies an area within a certain range from the store, for example, within a predetermined time on foot from the store. In the example illustrated in the present figure, the stores that are not located on the roadside are classified into any of three groups being a residential location, a mixed location, and a business location.

Further, these groups to which the stores are classified may be further divided into a plurality of subgroups. In such a case, the subgroups are defined by using other attributes, for example, a sales trend of a product, e.g., the best-selling product (or product category) (classes in the lateral direction in FIG. 2). Herein, the sales trend of a product is, for example, a ratio of a sales result of the product of the store to the average value of the sales result of the product per store of the local government (for example, a prefecture or a municipality) to which the store belongs. The product having the largest ratio is defined as a subgroup to which the store is to belong. Note that the sales trend of a product may be determined by the day of the week and the time zone. In such a case, the subgroup is determined by the day of the week and by the time zone.

The storage unit 160 stores information indicating which group (or a combination of a group and a subgroup when a subgroup is also defined) each of a plurality of stores belongs to. The second store selection unit 120 selects, as the second store, another store belonging to the same group (or a combination of a group and a subgroup) as the first store. Herein, when there are a plurality of other stores, the second store selection unit 120 selects the plurality of stores as the second stores.

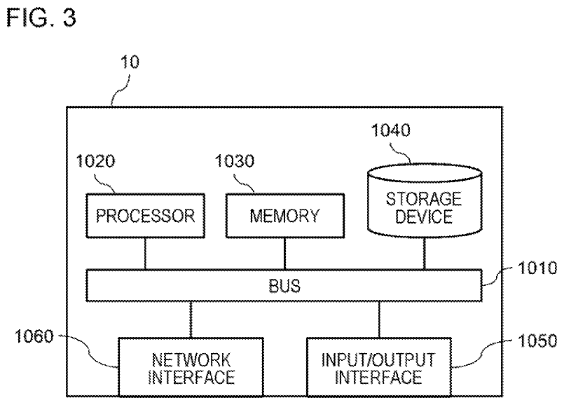

FIG. 3 is a diagram illustrating an example of a hardware configuration of the sales information processing apparatus 10. The sales information processing apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from one another. However, the method of connecting the processors 1020 and the like to one another is not limited to bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a hard disk drive (HDD), a solid state drive (SSD), a memory card, a read only memory (ROM), or the like. The storage device 1040 stores program modules which implement each of the functions (for example, the first store acquisition unit 110, the second store selection unit 120, the sales data acquisition unit 130, and the graph display unit 140) of the sales information processing apparatus 10. The processor 1020 reads and executes each of the program modules on the memory 1030, and thereby each function associated with the program modules are implemented. The storage device 1040 also functions as the storage unit 160.

The input/output interface 1050 is an interface for connecting the main body of the sales information processing apparatus 10 and various input/output devices. For example, the display 150 communicates with the main body of the sales information processing apparatus 10 via the input/output interface 1050.

The network interface 1060 is an interface for connecting the sales information processing apparatus 10 to a network. The network is, for example, a local area network (LAN) or a wide area network (WAN). The method by which the network interface 1060 connects to the network may be a wireless connection or a wired connection. For example, in a case where the sales information processing apparatus 10 is installed in a management center, the sales information processing apparatus 10 may communicate with a store terminal via the network interface 1060.

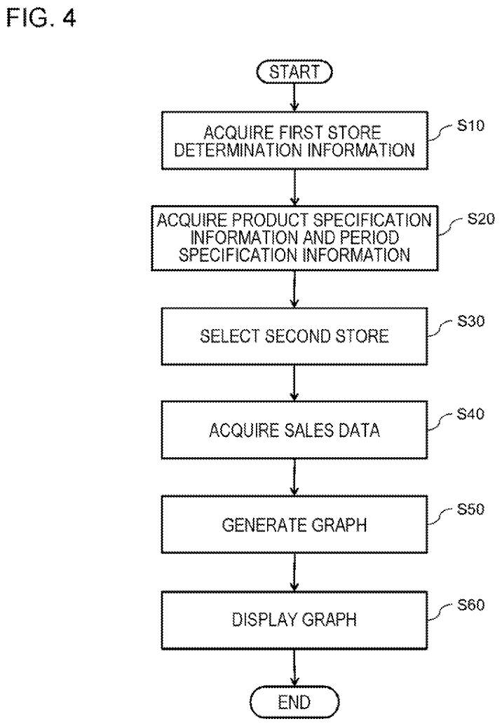

FIG. 4 is a flowchart illustrating one example of processing performed by the sales information processing apparatus 10. First, the store clerk of the first store inputs the first store discrimination information to the first store acquisition unit 110 of the sales information processing apparatus 10. Note that, in a case where the sales information processing apparatus is installed in the first store, the first store discrimination information may be stored in the storage unit 160 in advance. In such a case, the first store acquisition unit 110 acquires the first store discrimination information from the storage unit 160 (step S10).

Further, the store clerk of the first store inputs, to the sales information processing apparatus 10, product specification information of a product for which the sales result is to be checked and period specification information for specifying the period to be the target of the sales result. The sales data acquisition unit 130 acquires the product specification information and the period specification information (step S20).

The second store selection unit 120 selects the second store by using the first store discrimination information acquired by the first store acquisition unit 110. One example of the method of selecting the second store is as described with reference to FIGS. 1 and 2 (step S30).

Further, the sales data acquisition unit 130 acquires sales data of the first store and sales data of the second store from the storage unit 160. Herein, the sales data acquisition unit 130 acquires the sales data according to the product specification information and the period specification information acquired in step S20 (step S40). The sales data includes at least a sales result and a disposal result. The sales data acquisition unit 130 may further acquire, for the first store, sales data of a period before or after the period specification information acquired in step S20.

The graph display unit 140 generates a graph by using the sales data acquired by the sales data acquisition unit 130. Such graph has two axes each representing a sales result and a disposal result. In the graph, a first position corresponding to the first store and a second position corresponding to the second store are displayed (step S50).

Then, the graph display unit 140 causes the display 150 to display the graph (step S60). By looking at this graph, the store clerk of the first store can recognize whether the sales result and the disposal result of the first store are superior to those of the second store.

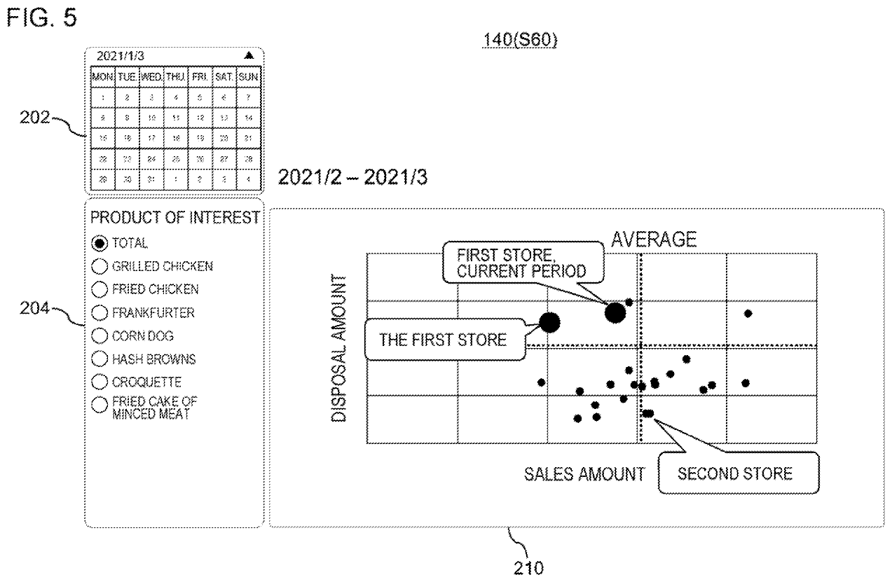

FIG. 5 is a diagram illustrating one example of a screen displayed on the display 150 in step S60 of FIG. 4. In the example illustrated in the present figure, the screen also serves as an initial screen, and has a period selection field 202 and a product selection field 204.

The period selection field 202 is a field for the store clerk to select and input the period specification information. In the example illustrated in the present figure, the period selection field 202 enables selection of the month and date being the start point and the month and date being the end point of the target period.

The product selection field 204 is a field for the store clerk to select a product for which the sales result is desired to be checked. In the product selection field 204, a plurality of products are able to be selected. The sales data acquisition unit 130 acquires information indicating the product selected in the product selection field 204 as product specification information.

Further, the screen also includes a graph display field 210. The graph displayed in the graph display field 210 is, for example, a two-dimensional graph, and the sales result and the disposal result of the product are represented by two axes. Such graph illustrates the sales result and the disposal result of the product selected in the product selection field 204 during the period selected in the period selection field 202. The graph also illustrates the position of the first store (first position) and the position of the second store (second position). Therefore, the store clerk of the first store may easily recognize the quality of the sales result and the disposal result of the first store when compared with another store (the second store).

The graph also illustrates, for the first store, a sales result and a disposal result for a period one period prior to the selected period. Therefore, the store clerk of the first store may easily recognize whether the sales result and the disposal result of the first store has improved.

The starting point of the graph is an average value of a plurality of stores (for example, the first store and the second store). Stores in the fourth quadrant of such graph are the best, since sales results are higher than average and disposal results are lower than average. On the other hand, stores in the second quadrant have sales results lower than average and disposal results higher than average, therefore it is necessary to improve both the sales policy and the ordering amount (the number of cooked items for in-store cooking items). Therefore, by recognizing which quadrant the first store belongs to in the graph, the store clerk of the first store can easily recognize the quality of the sales result and the disposal result of the first store.

Note that, in the example illustrated in the present figure, the graph illustrates the positions of each of the plurality of second stores. When any of the second stores is selected in the graph, the graph display unit 140 may display detailed information (for example, a store name or an address) of the second store. This detailed information is stored in the storage unit 160.

As described above, according to the present example embodiment, the store clerk of the first store can easily recognize the sales result and the disposal result of the first store by looking at the graph generated by the graph display unit 140 of the sales information processing apparatus 10. Therefore, the store clerk of the first store can easily recognize the quality of the sales result and the disposal result of the first store.

### Second Example Embodiment

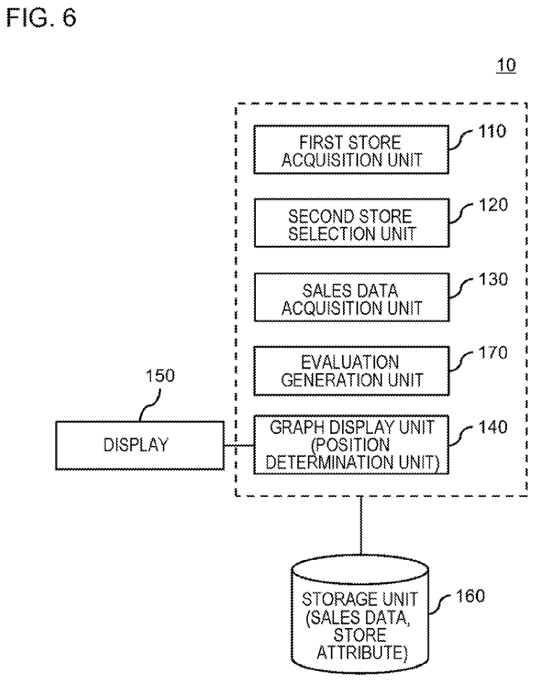

FIG. 6 is a diagram illustrating one example of a functional configuration of a sales information processing apparatus 10 according to the present example embodiment. The sales information processing apparatus 10 illustrated in the present figure is similar to the sales information processing apparatus 10 according to the first example embodiment except for the following points.

First, a graph display unit 140 (a position determination unit) generates a graph described with reference to FIG. 5 as in the first example embodiment. Then, the graph display unit 140 determines the quadrant to which the position (first position) of a first store in the graph belongs.

Then, an evaluation generation unit 170 generates evaluation information of the first store by using the quadrant determined by the graph display unit 140. The graph display unit 140 also causes the display unit 150 to display the generated evaluation information.

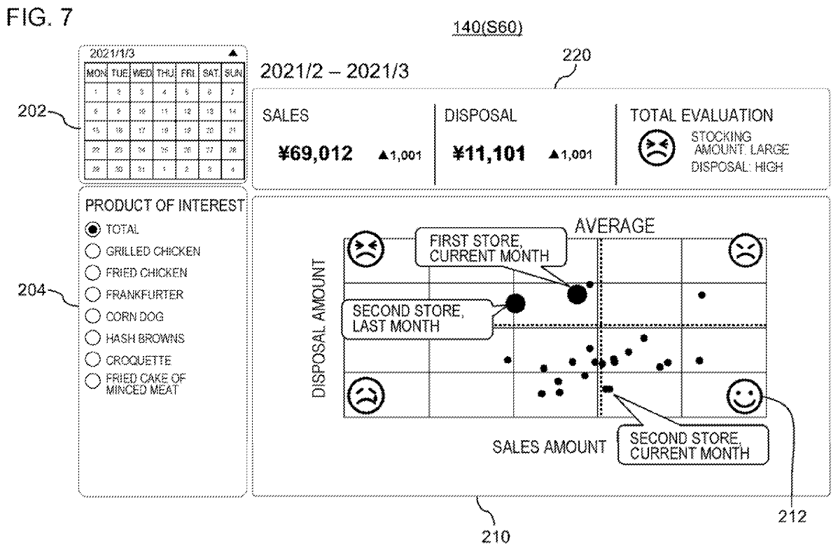

FIG. 7 is a diagram illustrating one example of a screen displayed on the display 150 in the present example embodiment. The present figure is related to FIG. 5 in the first example embodiment. In the example illustrated in the present figure, the graph display unit 140 causes the display 150 to display a period selection field 202, a product selection field 204, and a graph display field 210 as in the first example embodiment. The graph display unit 140 also causes the display 150 to display an evaluation display field 220. The evaluation display field 220 displays the evaluation information generated by the evaluation generation unit 170.

Specifically, as described with reference to FIG. 5, stores belonging to the fourth quadrant in such graph are the best, since sales results are higher than average and disposal results are lower than average. On the other hand, stores in the second quadrant have sales results lower than the average and disposal results higher than the average, therefore it is necessary to improve both the sales policy and the ordering amount (the number of cooked items for in-store cooking items). Although stores in the first quadrant have sales results higher than the average, disposal results are higher than the average, hence it is necessary to improve the ordering amount (the number of cooked items for in-store cooking items). Further, although stores in the third quadrant have disposal results lower than the average, sales results are lower than the average, and hence it is necessary to improve at least one of the sales policy and the ordering amount (the number of cooked items for in-store cooking items).

Then, the evaluation generation unit 170 sets the stores belonging to the fourth quadrant to high evaluation, and sets the stores belonging to the second quadrant to low evaluation. In addition, the evaluation generation unit 170 makes the store belonging to the first quadrant or the third quadrant a medium evaluation.

Note that, the evaluation display field 220 also displays a sales result (for example, a sales amount) and a disposal result (for example, a disposal amount).

Further, in FIG. 7, in each quadrant of the graph, a mark 212 indicating an evaluation result of the quadrant is also displayed. Therefore, the store clerk of the first store may easily recognize the evaluation of the quadrant to which the first store belongs.

Note that, in the present example embodiment, the graph display unit 140 may not display the graph display field 210 on the display 150.

As described above, according to the present example embodiment, similarly to the first example embodiment, the store clerk of the first store may easily recognize the quality of the sales result and the disposal result of the first store. Further, the sales information processing apparatus 10 displays the evaluation display field 220 on the display 150. Therefore, the store clerk of the first store may more easily recognize the quality of the sales result and the disposal result of the first store.

Although the example embodiments of the present invention have been described above with reference to the drawings, these are examples of the present invention, and various configurations other than the above may be adopted.

Further, in the plurality of flowcharts used in the above description, a plurality of steps (processing) are described in order, but the execution order of the steps being executed in each example embodiment is not limited to the order described above. In each of the example embodiments, the order of the steps being illustrated may be changed within a range that does not interfere with the contents. Further, the above-described example embodiments may be combined within a range in which the contents do not conflict with one another.

A part or the whole of the above-described example embodiments may also be described as the following supplementary notes, but are not limited thereto.

1. A sales information processing apparatus including:
a sales data acquisition unit that acquires sales data which enable determination of a sales result and a disposal result of a first store, and a sales result and a disposal result of a second store; and
a graph display unit that displays, on a display, a graph having two axes representing a sales result and a disposal result, and displays, in the graph, a first position corresponding to the first store and a second position corresponding to the second store by using the sales data.
   2. The sales information processing apparatus according to supplementary note 1, wherein,
in the graph, zero point of each axis is an average value of a plurality of stores, and
the sales information processing apparatus further including
   evaluation information generating unit that generates evaluation information of the first store by using a quadrant to which the first position belongs in the graph.
      3. The sales information processing apparatus according to supplementary note 1 or 2, further including:
a first store acquisition unit that acquires first store determination information for determining the first store; and
a second store selection unit that acquires, from a store attribute storage unit that stores an attribute of a store for each of a plurality of stores, an attribute associated with the first store determination information, and selects the second store by using the acquired attribute and the store attribute storage unit.
   4. A sales information processing apparatus including:
a sales data acquisition unit that acquires, from a sales storage unit that stores data of each of a plurality of stores, sales data which enable determination of a sales result and a disposal result of a first store; and
a position determination unit that determines a quadrant to which a first position corresponding to the sales data belongs in a graph having at least two axes representing a sales result and a disposal result, wherein,
in the graph, zero point of each axis is an average value of a plurality of stores, and
the sales information processing apparatus further including
   an evaluation generation unit that generates evaluation information of the first store by using the quadrant determined by the position determination unit.
      5. The sales information processing apparatus according to supplementary note 4, further including:
a first store acquisition unit that acquires first store determination information for determining the first store; and
a second store selection unit that reads out, from a store attribute storage unit that stores an attribute of a store for each of a plurality of stores, an attribute associated with the first store determination information, and selects the plurality of stores by using the read out attribute and the store attribute storage unit.
   6. The sales information processing apparatus according to supplementary note 3 or 5, wherein
the attribute includes information relating to a location of the store and information relating to a sales trend of a product in the store.
   7. The sales information processing apparatus according to any one of supplementary notes 1 to 6, wherein
the sales data indicates sales of a specific product, and
the sales data acquisition unit acquires product specification information specifying the specific product, and acquires the sales data of a product indicated by the product specification information.
   8. The sales information processing apparatus according to any one of supplementary notes 1 to 7, wherein
the sales data indicates sales of a specific period, and
the sales data acquisition unit acquires period specification information specifying the specific period, and acquires the sales data of a period indicated by the period specification information.
   9. A sales information processing method including,
by a computer to execute:
sales data acquisition processing of acquiring sales data which enable determination of a sales result and a disposal result of a first store, and a sales result and a disposal result of a second store; and
graph display processing of displaying, on a display, a graph having two axes representing a sales result and a disposal result, and displaying, in the graph, a first position corresponding to the first store and a second position corresponding to the second store by using the sales data.
   10. The sales information processing method according to supplementary note 9, wherein,
in the graph, zero point of each axis is an average value of a plurality of stores, and
the sales information processing method further including,
by the computer to execute
   an evaluation information generating unit that generates evaluation information of the first store by using a quadrant to which the first position in the graph belongs.
      11. The sales information processing method according to supplementary note 9 or 10, further including,
by the computer to execute:
first store acquisition processing of acquiring first store determination information for determining the first store; and
second store selection processing of acquiring, from a store attribute storage unit that stores an attribute of a store for each of a plurality of stores, an attribute associated with the first store determination information, and selecting the second store by using the attribute and the store attribute storage unit.
   12. A sales information processing method including,
by a computer to execute:
sales data acquisition processing of acquiring, from a sales storage unit that stores data of each of a plurality of stores, sales data which enable determination of a sales result and a disposal result of a first store; and
position determination processing of determining a quadrant to which a first position corresponding to the sales data belongs in a graph having at least two axes representing a sales result and a disposal result, wherein,
in the graph, zero point of each axis is an average value of a plurality of stores, and
the sales information processing method further including,
by the computer to execute
   evaluation generation processing of generating evaluation information of the first store by using the quadrant determined in the position determination processing.
      13. The sales information processing method according to supplementary note 12, further including,
by the computer to execute:
first store acquisition processing of acquiring first store determination information for determining the first store; and
second store selection processing of reading out, from a store attribute storage unit that stores attributes of a store for each of the plurality of stores, an attribute associated with the first store determination information, and selecting the plurality of stores by using the attribute and the store attribute storage unit.
   14. The sales information processing method according to supplementary note 11 or 13, wherein
the attribute includes information relating to a location of the store and information relating to a sales trend of a product in the store.
   15. The sales information processing method according to any one of supplementary notes 9 to 14, wherein
the sales data indicates sales of a specific product, and
the sales information processing method further including,
by the computer,
in the sales data acquisition processing, acquiring product specification information specifying the specific product, and acquiring the sales data of a product indicated by the product specification information.
   16. The sales information processing method according to any one of supplementary notes 9 to 15, wherein
the sales data indicates sales of a specific period, and
the sales information processing method further including,
by the computer,
in the sales data acquisition processing, acquiring period specification information specifying the specific period, and acquiring the sales data of a period indicated by the period specification information.
   17. A program causing a computer to include:
a sales data acquisition function of acquiring sales data which enable determination of a sales result and a disposal result of a first store, and a sales result and a disposal result of a second store; and
a graph display function of displaying, on a display, a graph having two axes representing a sales result and a disposal result, and displaying, in the graph, a first position corresponding to the first store and a second position corresponding to the second store by using the sales data.
   18. The program according to supplementary note 17, wherein,
in the graph, zero point of each axis is an average value of a plurality of stores, and
the program further causing the computer to include
   an evaluation information generation function of generating evaluation information of the first store by using a quadrant to which the first position belongs in the graph.
      19. The program according to supplementary note 17 or 18, further causing the computer to include:
a first store acquisition function of acquiring first store determination information for determining the first store; and
a second store selection function of acquiring, from a store attribute storage unit that stores an attribute of the store for each of a plurality of stores, an attribute associated with the first store determination information, and selecting the second store by using the attribute and the store attribute storage unit.
   20. A program causing a computer to include:
a sales data acquisition function of acquiring, from a sales storage unit that stores data of each of a plurality of stores, sales data which enable determination of a sales result and a disposal result of a first store; and
a position determination function of determining a quadrant to which a first position corresponding to the sales data belongs in a graph having at least two axes representing a sales result and a disposal result, wherein,
in the graph, zero point of each axis is an average value of a plurality of stores, and
the program further causing the computer to include
   an evaluation generation function of generating evaluation information of the first store by using the quadrant determined by the position determination function.
      21. The program according to supplementary note 20, further causing the computer to include:
a first store acquisition function of acquiring first store determination information for determining the first store; and
a second store selection function of reading out, from a store attribute storage unit that stores an attribute of a store for each of a plurality of stores, an attribute associated with the first store determination information, and selecting the plurality of stores by using the acquired attribute and the store attribute storage unit.
   22. The program according to supplementary note 19 or 21, wherein
the attribute includes information relating to a location of the store and information relating to a sales trend of a product in the store.
   23. The program according to any one of supplementary notes 17 to 22, wherein
the sales data indicates sales of a specific product, and
the sales data acquisition function acquires product specification information specifying the specific product, and acquires the sales data of a product indicated by the product specification information.
   24. The program according to any one of supplementary notes 17 to 23, wherein
the sales data indicates sales for a specific period, and
the sales data acquisition function acquires period specification information specifying the specific period, and acquires the sales data for a period indicated by the period specification information.

### REFERENCE SIGNS LIST

10 Sales information processing apparatus
110 First store acquisition unit
120 Second store selection unit
130 Sales data acquisition unit
140 Graph display unit
150 Display
160 Storage unit

What is claimed is:

1. A sales information processing apparatus comprising:
at least one memory configured to store one or more instructions; and
at least one processor configured to execute the one or more instructions to:
acquire sales data which enable determination of a sales result and a disposal result of a first store, and a sales result and a disposal result of a second store; and
display, on a display, a graph having two axes representing a sales result and a disposal result, and displays, display, in the graph, a first position corresponding to the first store and a second position corresponding to the second store by using the sales data.

2. The sales information processing apparatus according to claim 1, wherein,
in the graph, zero point of each axis is an average value of a plurality of stores, and
the processor is further configured to execute the one or more instructions to generate evaluation information of the first store by using a quadrant to which the first position belongs in the graph.

3. The sales information processing apparatus according to claim 1, wherein the processor is further configured to execute the one or more instructions to:
acquire first store determination information for determining the first store; and
acquire, from store attribute storage unit that stores an attribute of a store for each of a plurality of stores, an attribute associated with the first store determination information, and select the second store by using the acquired attribute and the store attribute storage unit.

4.-6. (canceled)

7. The sales information processing apparatus according to claim 1, wherein
the sales data indicate sales of a specific product, and
the processor is further configured to execute the one or more instructions to acquire product specification information specifying the specific product, and acquire the sales data of a product indicated by the product specification information.

8. The sales information processing apparatus according to claim 1, wherein
the sales data indicate sales of a specific period, and
the processor is further configured to execute the one or more instructions to acquire period specification information specifying the specific period, and acquire the sales data of a period indicated by the period specification information.

9. A sales information processing method comprising,
by a computer to execute:
acquiring sales data which enable determination of a sales result and a disposal result of a first store, and a sales result and a disposal result of a second store; and
displaying, on a display, a graph having two axes representing a sales result and a disposal result, and displaying, in the graph, a first position corresponding to the first store and a second position corresponding to the second store by using the sales data.

10. (canceled)

11. A non-transitory storage medium storing a program causing a computer to:
acquire sales data which enable determination of a sales result and a disposal result of a first store, and a sales result and a disposal result of a second store; and
display, on a display, a graph having two axes representing a sales result and a disposal result, and display, in the graph, a first position corresponding to the first store and a second position corresponding to the second store by using the sales data.

12. (canceled)
